(19) United States
(12) Patent Application Publication
(10) Pub. No.: US 2021/0126320 A1
(43) Pub. Date: Apr. 29, 2021

(54) BATTERY SEPARATOR WITH LITHIUM-ION CONDUCTOR COATING

(71) Applicants: University of Washington, Seattle, WA (US); Pacific Northwest National Laboratory, Richland, WA (US)

(72) Inventors: Huilin Pan, Richland, WA (US); Jie Xiao, Richland, WA (US); Jun Liu, Richland, WA (US); Jihui Yang, Seattle, WA (US); Shanyu WANG, Seattle, WA (US)

(73) Assignees: University of Washington, Seattle, WA (US); Pacific Northwest National Laboratory, Richland, WA (US)

(21) Appl. No.: 17/253,017

(22) PCT Filed: Jun. 19, 2019
(86) PCT No.: PCT/US2019/037988

§ 371 Date: Dec. 16, 2020

Related U.S. Application Data
(60) Provisional application No. 62/687,125, filed on Jun. 19, 2018.

(51) Int. Cl. H01M 50/451; H01M 10/0525; H01M 50/403; H01M 50/417; H01M 50/434; H01M 50/457

(52) U.S. Cl. CPC H01M 50/451; H01M 10/0525; H01M 50/457; H01M 50/417; H01M 50/434; H01M 50/403

(57) ABSTRACT

The present disclosure presents a separator for a lithium-containing battery, including a polymeric membrane; and a ceramic coating on at least one surface of the polymeric membrane, wherein the ceramic coating is chemically reactive with lithium ions to provide an ionically conductive and electrically insulating surface layer; and wherein the ceramic coating has a thickness of about 1 μm or more and about 10 μm or less.

### CROSS-REFERENCE TO RELATED APPLICATION

This application claims the benefit of U.S. patent application Ser. No. 62/687,125, filed Jun. 19, 2018, the disclosure of which is incorporated herein by reference in its entirety.

### STATEMENT OF GOVERNMENT LICENSE RIGHTS

This invention was made with government support under Grant Nos. DE-AC05-76RL01830 and DE-EE0007763, awarded by the Department of Energy. The government has certain rights in the invention.

### BACKGROUND

Lithium-ion batteries (LIBs) have been the most popular energy storage enablers for portable electronics, large-scale smart grids, and electric transportations, owing to their merits including high energy and power densities, long cycle life, and low self-discharging, etc. Similar to the architecture of basic galvanic cells, a LIB is composed of three main functional components, namely the anode (negative electrode), cathode (positive electrode), and electrolyte. A separator is placed in between the anode and the cathode to prevent the physical contact of the two electrodes (and thus causing electrical short of the two electrodes), while up-taking electrolyte and enabling ion transport. The separator generally does not directly participate in any reaction in the batteries but plays an important role in determining the battery performance, including cycle life, safety, energy density, and power density, through influencing the cell kinetics. In general, a battery separator should be chemically, mechanically, and electrochemically stable under the strongly reactive environment inside the battery during operation. Thus, the battery separator should not adversely interact with the electrolyte and/or electrode materials, and should have no deleterious effect on the battery performance (e.g., energy density, cycle life, safety).

To meet the ever-growing demand of high energy LIBs for electric transportation and grid storage, the energy density of current LIBs (˜200-300 Wh kg⁻¹) needs to be increased. However, the low specific capacity of the graphite anode (˜372 mAh g⁻¹) in state-of-the-art LIBs primarily limits the further improvement in energy density. Lithium (Li) metal with the highest capacity (3860 mAh g⁻¹) and lowest potential (−3.05 V vs. SHE) has long been considered the ‘Holy Grail’ of LIB anode. Li dendrite growth due to the inhomogeneous Li plating/stripping processes, however, causes serious safety concern and prohibits its practical applications. Meanwhile, the low coulombic efficiency of Li metal, originating from the severe Li/electrolyte reactions and infinite volume change, results in rapid capacity degradation and short cycle life of Li metal batteries.

A considerable number of advances have been made in the past 10 years to suppress dendrite formation and penetration, and to reinforce the protection of the Li anode to extend its cycle life. Unfortunately, only limited success has been achieved to solve the challenges in using Li metal anodes. A prerequisite of utilizing Li anode in carbonate electrolyte is to physically separate the anode and the electrolyte by in situ or ex situ formation of stable solid electrolyte interphases (SEIs), which can retain its structure and integrity during the repeated Li stripping/plating.

The SEI formed on Li surface in carbonate electrolyte is thin and fragile and can easily be broken during Li stripping, especially at high current densities (>0.5 mA cm⁻²). Forming an artificial SEI layer on Li surface, through electrolyte additives or Li surface modifications (coating or deposition), is widely used and has been demonstrated effective to improve Li cycling stability. Separator coating can help to uptake electrolyte and separate Li metal from electrolyte so as to alleviate the electrolyte/Li reactions, and thus protect Li. The additional advantage of a Li-ion conductor coating, as compared to other ceramic or polymer coatings, is its high Li-ion conductivity, which can provide good Li-ion transport through the separator and thus help retain the rate capability.

Furthermore, depending on their stability against Li metal, Li-ion conductors can be categorized into reactive and nonreactive types, which possess distinct behaviors; with the potential to greatly influence the Li metal Coulombic efficiency and cycle life. The reactive ones either form in situ a self-terminating SEI layer between the Li metal and the coating layer, or completely turn into an SEI. On the contrary, the nonreactive Li-ion conductors act solely as an artificial SEI.

There is a need for a separator for a lithium-containing battery that can prolong the lifetime, safety, and stability of the lithium-containing battery. The present disclosure seeks to fulfill this need and provides further related advantages.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, the present disclosure features a separator for a lithium-containing battery, including a polymeric membrane; and a ceramic coating on at least one surface of the polymeric membrane. The ceramic coating is chemically reactive with lithium to provide an ionically conductive and electrically insulating surface layer; and the ceramic coating is relatively thin, having a thickness of about 1 μm or more and about 10 μm or less.

In another aspect, the present disclosure features a lithium-containing battery, including an anode, a cathode, and the separator described herein. In some embodiments, the anode can include graphite or graphene. The cathode can include a lithium-containing layered oxide, a lithium-containing polyanion, or a lithium-containing spinel. In certain embodiments, the anode can include metallic lithium. The cathode can include a metal oxide, such as manganese oxide.

In a further aspect, the present disclosure features a method of making a separator described herein. The method can include providing a slurry including one or more Li₁₊ₓAlₓTi₂₋ₓ(PO₄)₃ (LATP) powder(s), a polymeric binder, and a solvent; coating the slurry on the polymeric membrane to provide a coated polymeric membraned, and drying the coated polymeric membrane to provide the separator described herein.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1A is a graph showing the conductivity of different LATPs at room temperature, as described, for example, in S. Wang et al., Solid State Ionics 268, 110 (2014), incorporated herein in its entirety.

FIG. 1B is an Arrhenius plot for the ionic conductivity of hydrothermally synthesized LATP, as described, for example, in K. M. Kim et al., Electrochim. Acta 176, 1364 (2015), incorporated herein in its entirety.

FIG. 2A is a graph showing bulk, grain boundary and total conductivities of Li_{1.4}FexAl_{0.4-x}Ti_{1.6}(PO₄)₃ (x=0−0.4) at room temperature (e.g., 23° C.), as described, for example, in P. Zhang et al., Solid State Ionics 263, 27 (2014), incorporated herein in its entirety.

FIG. 2B is a graph showing total conductivities of Li_{1.4}FexCr_{0.4-x}Ti_{1.6}(PO₄)₃ (x=0−0.4) at room temperature, as described, for example, in P. Zhang et al., Solid State Ionics 272, 101 (2015), incorporated herein in its entirety.

FIG. 3A shows the electrical conductivities of the Li_{1.4}Al_{0.4}Ti_{1.6-x}Geₓ(PO₄)₃ (x=0−1.6) at 25° C., as described, for example, in P. Zhang et al., Solid State Ionics 253, 175 (2013), incorporated herein in its entirety.

FIG. 3B shows the aluminum content dependence of the bulk, grain boundary and total conductivities of Li_{2+x-y}AlₓNb_{y}Ti_{2-x-y}(PO₄)₃ at 25° C. as a function of y, as described, for example, in X. Shang et al., Solid State Ionics 297, 43 (2016), incorporated herein in its entirety.

FIG. 4A shows conductivity plots for LATP and samples doped at x=0.03 concentration at 423 K, as described, for example, in D. H. Kothari and D. K. Kanchan, Physica B: Condensed Matter 501, 90 (2016), incorporated herein in its entirety.

FIG. 4B shows the Arrhenius plots for electrical conductivities of Li_{1.3}Al_{0.3-x}YₓTi_{1.7}(PO₄)₃ electrolytes, as described, for example, in E. Zhao et al., J. Alloys Compd. 782, 384 (2019), incorporated herein in its entirety.

FIG. 5A is an illustration of the design of a Li metal battery with an unreactive ceramic-coated separator.

FIG. 5B is an illustration of the design of a Li metal battery with a ceramic-coated separator that is reactive with Li metal.

FIG. 6A shows the X-ray diffraction (XRD) patterns of as-synthesized and ball milled Li₇La₃Zr₂O₁₂ (LLZO) powders.

FIG. 6B is a graph of the ionic and electronic conductivities of the dense LLZO pellet.

FIG. 6C is a micrograph of the surface of the LLZO/polyethylene oxide (PEO) coating on the Celgard 2325 separator.

FIG. 6D is a micrograph of the cross section of the LLZO/PEO coating layer on the Celgard 2325 separator, the coating thickness was ˜15 μm.

FIG. 7A is a graph of the cycling stability (C/3) of cells with pristine and LLZO-coated separators, and the cell loading was 4 mAh/cm².

FIG. 7B is a graph of the voltage profiles (C/10 at 1^{st} cycle and C/3 at 5^{th} cycle) of the cells with pristine and LLZO-coated separators.

FIG. 8A is a graph of the XRD patterns of as-synthesized and ball-milled LATP powders, both of which show single phase;

FIG. 8B is a graph of the ionic conductivity of a LATP dense pellet, and the inset shows the as-synthesized LATP powders;

FIG. 8C is a micrograph the surface of LATP coating on the Celgard 2325 separator.

FIG. 8D is a micrograph the surface of polyvinylidene fluoride (PVDF) coating on the Celgard 2325 separator.

FIG. 8E is a micrograph of the cross section of the LATP/PVDF coating on the Celgard 2325 separator and the coating thickness is controlled to be ˜5 μm.

FIG. 8F is the Nyquist plot of the pristine and coated separators in stainless steel (SS) symmetric cells (SS/SS) with baseline electrolyte, which demonstrates the LATP/PVDF coating doesn't impede the ion transport.

FIG. 9 is a series of photographs of the thermal shrinkage of the pristine and LATP-coated separators at 90° C. and 120° C. for 30 min.

FIG. 10 is a series of images of contact angle tests of the pristine and LATP-coated separators using the carbonate electrolyte.

FIG. 11 is a series of micrographs of the 1^{st} Li deposits in Li/Cu cell with the pristine and LATP-coated separators, and the deposition current densities are 0.25 mA cm⁻² and 1.0 mA cm⁻².

FIG. 12A is a graph of the Coulombic efficiencies of the Li/Cu cells with the pristine and LATP coated separators, and the cycling current density is 0.5 mA cm⁻² and deposition amount is ˜1.0 mAh cm⁻².

FIG. 12B is a graph of the voltage profiles at the 1^{st} cycle for the cells with the pristine and LATP-coated separators, and the current density is 0.5 mA cm⁻²;

FIG. 12C is a graph of the voltage profiles at the 50^{th} cycle for the cells with the pristine and LATP-coated separators, and the current density is 0.5 mA cm⁻²;

FIG. 12D is a graph the voltage profiles at the 100^{th} cycle for the cells with the pristine and LATP-coated separators, and the current density is 0.5 mA cm⁻²;

FIG. 13 is a graph showing the cycling stability of Li/Li symmetric cells with the pristine and LATP-coated separators, and the cycling current density is 0.1 mA cm⁻² for the first three cycles and 1.0 mA cm⁻² for the subsequent cycles;

FIG. 14 is a graph of the rate capability of the Li/LiNi_{0.8}Mn_{0.1}Co_{0.1}O₂ (NMC811) cells with pristine and LATP-coated separators;

FIG. 15A is a graph of the cycling stability of Li/NMC811 high loading cells (4.0 mAh cm⁻²) with the pristine and LATP-coated separators, and the discharge rate is C/10 (0.4 mA cm⁻²) for the first three cycles and C/3 (1.33 mA cm⁻²) for the subsequent cycles;

FIG. 15B is a graph of the voltage profiles of the Li/NMC811 with pristine Celgard 2325 separator;

FIG. 15C is a graph of the voltage profiles of the Li/NMC811 with LATP-coated Celgard 2325 separator.

FIG. 16 is a graph of the specific capacity vs. cycle number for a coin cell using LATP-coated polypropylene (PP) separator.

FIG. 17 is a graph of the specific capacity vs. cycle number for a pouch cell using LATP-coated PP separator.

The particular arrangements shown in the Figures should not be viewed as limiting. It should be understood other embodiments may include more or less of each element shown in a given Figure. Further, some of the illustrated elements may be combined or omitted. Yet further, an example embodiment may include elements not illustrated in the Figures.

### DETAILED DESCRIPTION

The present disclosure presents a separator for a lithium-containing battery, including a polymeric membrane; and a ceramic coating on at least one surface of the polymeric membrane, wherein the ceramic coating is chemically reactive with lithium metal to provide an ionically conductive (e.g., Li-ion conductive) and electrically insulating surface layer; and wherein the ceramic coating has a thickness of about 1 μm or more and about 10 μm or less. When the ceramic coating is present on one surface (e.g., one side) of the polymeric membrane, the ceramic-coated side is the side facing the lithium-containing electrode in a lithium-containing battery into which the separator is to be incorporated. In some embodiments, the ceramic coating is on both surfaces of a polymeric membrane, such that when the separator is incorporated into a lithium-containing battery, a ceramic-coated surface faces both the anode and cathode of the lithium-containing battery.

When the separator is incorporated into a lithium-containing battery, during battery operation, an interfacial layer between the separator and the lithium-containing electrode forms in situ after lithium metal reacts with the ceramic coating. The interfacial layer is ionically conductive (e.g., Li-ion conducting) and electrically insulating, thereby suppressing the formation of lithium dendrites. Unlike a barrier that physically blocks the penetration of formed lithium dendrites, the separator of the present disclosure chemically limits the formation of the dendrites in a first instance. Therefore, the ceramic coating on the separator can be relatively thin. For example, the ceramic coating can have a thickness of about 1 μm or more (e.g., about 2 μm or more, about 4 μm or more, about 5 μm or more, about 6 μm or more, or about 8 μm or more) and/or about 10 μm or less (e.g., about 8 μm or less, about 6 μm or less, about 5 μm or less, about 4 μm or less, or about 2 μm or less). In some embodiments, the ceramic coating has a thickness of about 1 μm or more and/or about 5 μm or less. In certain embodiments, the ceramic coating has a thickness of about 1 μm.

The ionic conductivity of the ceramic coating material can be measured using electrochemical impedance spectroscopy, as known to a person of ordinary skill in the art. The ionic conductivity can be about 0.5 mS/cm or more (e.g., about 1 mS/cm or more, about 2 mS/cm or more, about 3 mS/cm or more, or about 4 mS/cm or more) and/or about 5 mS/cm or less (e.g., about 4 mS/cm or less, about 3 mS/cm or less, about 2 mS/cm or less, or about 1 mS/cm or less).

### Definitions

As used herein, the term “battery” is used interchangeably with “cell.”

As used herein, the term “dendrites” refers to the needle-like dendritic crystals that form on the surface of a lithium electrode during charging/discharging of a lithium battery.

Example devices, methods, and systems are described herein. It should be understood the words “example,” “exemplary,” and “illustrative” are used herein to mean “serving as an example, instance, or illustration.” Any embodiment or feature described herein as being an “example,” being “exemplary,” or being “illustrative” is not necessarily to be construed as preferred or advantageous over other embodiments or features. The example embodiments described herein are not meant to be limiting. It will be readily understood aspects of the present disclosure, as generally described herein, and illustrated in the figures, can be arranged, substituted, combined, separated, and designed in a wide variety of different configurations, all of which are explicitly contemplated herein.

As used herein, with respect to measurements, “about” means +/−5%.

As used herein, a recited range includes the end points, such that from 0.5 mole percent to 99.5 mole percent includes both 0.5 mole percent and 99.5 mole percent.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

All of the references cited herein are incorporated by reference. Aspects of the disclosure can be modified, if necessary, to employ the systems, functions, and concepts of the above references and application to provide yet further embodiments of the disclosure. These and other changes can be made to the disclosure in light of the detailed description.

Specific elements of any foregoing embodiments can be combined or substituted for elements in other embodiments. Moreover, the inclusion of specific elements in at least some of these embodiments may be optional, wherein further embodiments may include one or more embodiments that specifically exclude one or more of these specific elements. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

### Ceramic-Coated Separators

As discussed above, the present disclosure features separators including a ceramic coating that can be used, for example, in high energy density lithium (Li) batteries (e.g., lithium metal batteries), including the design, fabrication method, and electrochemical testing results in high-energy batteries. The ceramic-coated separator can have numerous advantages, such as up-taking electrolytes, forming solid electrolyte interphases on a Li metal surface, mitigating Li/electrolyte reactions, mitigating Li dendrite growth, and prolonging the cycle life of the Li-containing batteries. In the Example below, the chemical and physical interactions between the ceramic coating and Li ions or metal, and the electrochemical behavior of the coated separator were demonstrated in Li/Li symmetric cells, Li/Cu cells, and high loading Li/LiNi_{1-a-b}MnₐCo_{b}O₂ (NMC (0≤a≥1; 0≤b≥1) cells. The ceramic-coated separator also does not impede ion transport across the separator.

In some embodiments, the ceramic layer has a shear modulus of about 50 GPa or more (e.g., about 52 GPa or more, about 55 GPa or more, or about 57 GPa or more) and/or about 60 GPa or less (e.g., about 57 GPa or less, about 55 GPa or less, or about 52 GPa or less). For example, the ceramic layer can have a shear modulus of about 55 GPa to about 60 GPa. In some embodiments, the ceramic layer has a shear modulus of about 50 GPa to about 60 GPa.

In some embodiments, the in situ generated ionically conductive and electrically insulating surface layer is a passivating layer. The passivating layer can inhibit the formation of lithium dendrites. In some embodiments, the passivating layer includes Li₃PO₄, AlPO₄, Li₄P₂O₇, TiPO₄, and/or Li_{c}(AlTi)O₂, where c is about 0.1 or more (e.g., about 0.3 or more, about 0.5 or more, about 0.7 or more, or 0.9 or more) and/or about 1 or less (0.9 or less, about 0.7 or less, about 0.5 or less, or about 0.3 or less).

In some embodiments, the ceramic coating includes lithium aluminum titanium phosphate (LATP). In certain embodiments, the ceramic coating consists essentially of LATP. In certain embodiments, the ceramic coating consists of LATP as the chemically reactive compound. The ceramic coating can include one or more binders, which can be a polymer such as poly(ethylene oxide) and/or polyvinylidene fluoride (PVDF).

In some embodiments, the ceramic coating includes LATP in an amount of 90 weight percent or more (e.g., 91 weight percent or more, 92 weight percent or more, 93 weight percent or more, or 94 weight percent or more) and/or 95 weight percent or less (e.g., 94 weight percent or less, 93 weight percent or less, 92 weight percent or less, or 91 weight percent or less). The balance of the ceramic coating can include, for example, one or more binders.

In some embodiments, the LATP has a formula of Li₁₊ₓAlₓTi₂₋ₓ(PO₄)₃, where x is 0.3 or more and 0.4 or less. The LATP can be doped. For example, a doped LATP can have a formula of Li₁₊ₓAl_{x-y}R_{y}Ti₂₋ₓ(PO₄)₃, where R is one or more dopants, x is about 0.3 or more and about 0.4 or less, and y is less than or equal to x (e.g., or y is less than x). In some embodiments, y can be about 0.1 or more (e.g., about 0.15 or more, about 0.2 or more, or about 0.3 or more) and/or about 0.4 or less (e.g., about 0.3 or less, about 0.2 or less, or about 0.15 or less). For example, the one or more dopants R can be Fe³⁺, Cr³⁺, Ge⁴⁺, Nb⁵⁺, Ga³⁺, Sc³⁺, and/or Y³⁺. In some embodiments, the one or more dopants are present in the LATP in an amount of about 1 mole % or more (e.g., about 3 mole % or more, about 5 mole % or more, about 7 mole % or more, or about 9 mole % or more) and/or about 10 molar % or less (e.g., about 9 mole % or less, about 7 mole % or less, about 5 mole % or less, or about 3 mole % or less).

In some embodiments, the LATP (including doped LATP) is synthesized by solid state reaction at a temperature of 800° C. or more and 1100° C. or less. The LATP can be in the form of particles, having a dimension of about 100 nm or more (e.g., about 200 nm or more, about 300 nm or more, about 400 nm or more, about 500 nm or more, about 600 nm or more, about 700 nm or more, about 800 nm or more, or about 900 nm or more) and/or about 1 μm or less (e.g., about 900 nm or less, about 800 nm or less, about 700 nm or less, about 600 nm or less, about 500 nm or less, about 400 nm or less, about 300 nm or less, or about 200 nm or less). The LATP particles can be obtained by high energy ball milling.

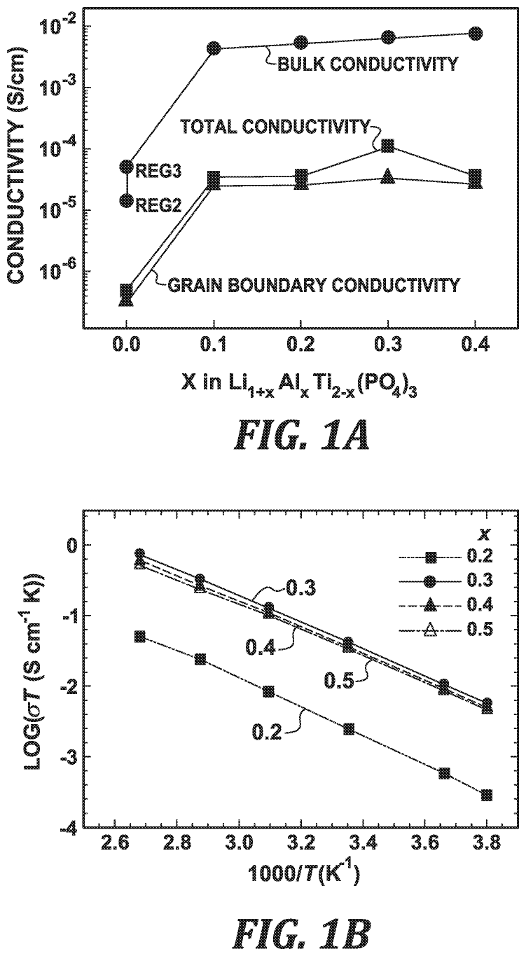

Without wishing to be bound by theory, it is believed that lithium content can depend on the total ionic conductivity of the LATP electrolyte. It is believed that by substituting Ti⁴⁺ with Al³⁺ in LiTi₂(PO₄)₃ (LTP) can result in a high ionic conductivity of 10⁻⁴ S cm⁻². The conductivity enhancement mechanism could be ascribed to the additional Li ions in the energetically favored M3 sites, the increase of electrolyte density, and the decreases of the impurity phase of the unit cell. The ionic conductivity of LATP can increase with the increase of Al content, and the highest value can be achieved when x=0.3 or 0.4, as shown in FIGS. 1A and 1B, and as described, for example, in G. J. Redhammer et al., Solid State Sci. 60, 99 (2016); S. Wang et al., Solid State Ionics 268, 110 (2014); Y. Zhang et al., Ceram. Int. 43, S598 (2017); and K. M. Kim et al., Electrochim. Acta 176, 1364 (2015).

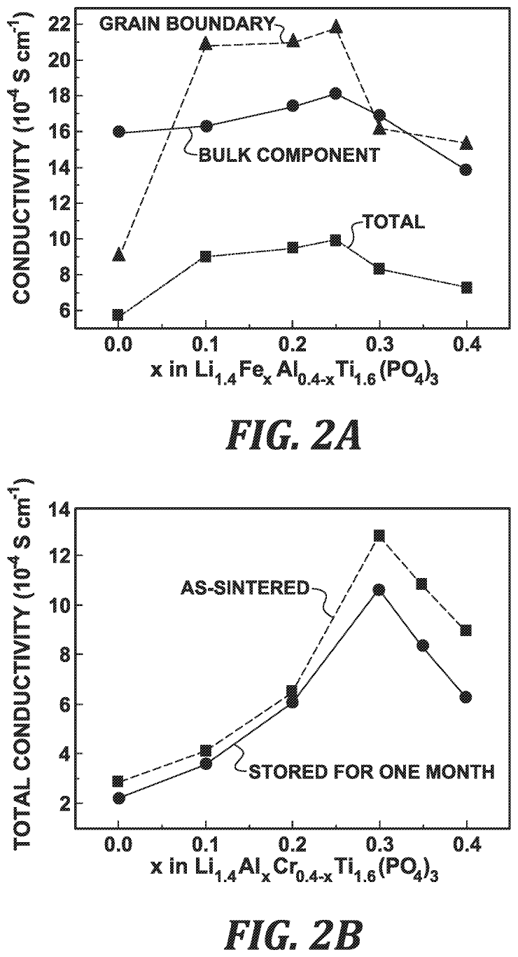

To further increase the ionic conductivity of LATP, extra doping can be conducted on LATP. For example, when LATP (x is 0.4) and is doped with Fe³⁺, Cr³⁺, and/or Ge⁴⁺, the highest total conductivities of 1.01×10⁻³ and 1.27×10⁻³ S cm⁻¹ at 25° C. can be observed for Li_{1.4}Fe_{0.25}Al_{0.15}Ti_{1.6}(PO₄)₃⁵ and Li_{1.4}Al_{0.3}Cr_{0.1}Ti_{1.6}(PO₄)₃ pellets, shown in FIGS. 2A and 2B, respectively; and as described, for example, in P. Zhang et al., Solid State Ionics 263, 27 (2014); and P. Zhang et al., Solid State Ionics 272, 101 (2015). Without wishing to be bound by theory, it is believed that he ionic conductivity changes with Fe³⁺ or Cr³⁺ doping could be explained by the interaction between ionic vacancies produced by the substitution of Ti⁴⁺ for M³⁺ and by the relative density increase of the sample, which contribute to the decrease of the grain boundary resistance.

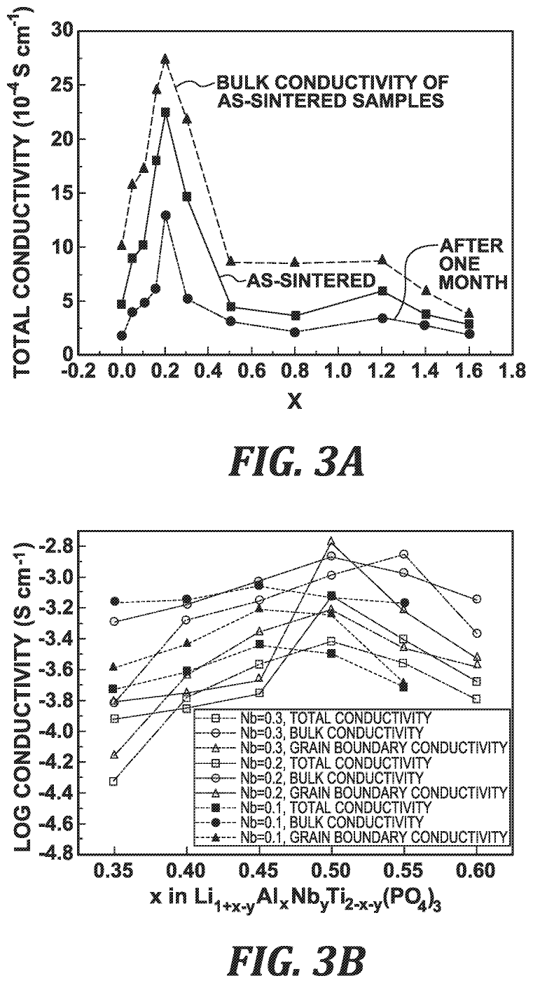

In some embodiments, for Ge-doped LATP, Li_{1.4}Al_{0.4}Ti_{1.4}Ge_{0.2}(PO₄)₃, the total conductivity of the sintered pellet can be 1.29×10⁻³ at 25° C. (FIG. 3A); and as described, for example, in P. Zhang et al., Solid State Ionics 253, 175 (2013). Without wishing to be bound by theory, the high total conductivity of Li_{1.4}Al_{0.4}Ti_{1.4}Ge_{0.2}(PO₄)₃ could be explained by the formation of a high lithium-ion mobility phase in the grains and a high grain boundary conductivity phase by the substitution of Ge for Ti.

In some embodiments, for the Nb⁵⁺-doped LATP, a highest total conductivity of 7.5×10⁻⁴ S cm⁻¹ at 25° C. was observed for Li_{1.3}Al_{0.50}Nb_{0.2}Ti_{1.3}(PO₄)₃, which is higher than that of Li_{1.3}Al_{0.3}Ti_{1.7}(PO₄)₃ (2.3×10⁻⁴) (FIG. 3B); as described, for example, in X. Shang et al., Solid State Ionics 297, 43 (2016). Without wishing to be bound by theory, it is believed that this can be ascribed to the better sinterability after Nb doping, leading to higher relative density and lowered grain-boundary resistance.

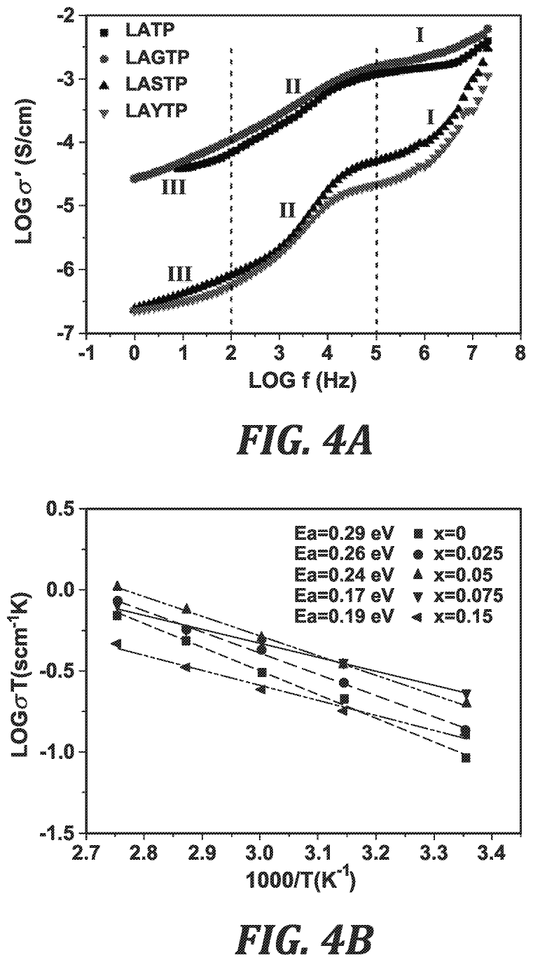

In the ternary NASICON Li_{1.3}Al_{0.3-x}RₓTi_{1.7}(PO₄)₃ system (R=Ga³⁺, Sc³⁺, Y³⁺, x is 0.3 or less, or x is less than 0.3), Ga³⁺ could substitute the Ti⁴⁺ at octahedral position, and the Al³⁺ at tetrahedral and octahedral positions in the LATP lattice, believed to be due to the similar ionic size with Al³⁺ and Ti⁴⁺, as described, for example, in D. H. Kothari, D. K. Kanchan, Physica B: Condensed Matter 501, 90 (2016). However, due to the mismatch ionic size between Al³⁺ and Sc³⁺ (Y³⁺), the substitution by Sc³⁺ (Y³⁺) for Al³⁺ at tetrahedral position is less likely. Therefore, Sc³⁺ (Y³⁺) dopants, get segregated towards grain boundaries, distorting the LATP lattice and blocking the Li⁺ motion near the M1 vacancy (FIG. 4A).

On the other hand, Li_{1.3}Al_{0.3}Ti_{1.7}(PO₄)₃ doped with Y³⁺ (concentration of 0.075) offered a highest electrical conductivity of 7.8×10−4 S/cm (FIG. 4B) at room temperature, higher than that of the pristine LATP electrolyte, as described, for example, in E. Zhao et al., J. Alloys Compd. 782, 384 (2019). Without wishing to be bound by theory, it is believed that the high ionic conductivity is mainly attributed to the reduction of grain boundary resistance which results from high electrolyte density. The YPO₄ phases in the doped electrolyte can segregate into the grain boundaries and promote effective densification of electrolyte.

In some embodiments, the ceramic coating of the separator is permeable to a liquid electrolyte and/or has good electrolyte wettability. In some embodiments, wettability can be assessed by measuring contact angles of a ceramic coating with an electrolyte. In some embodiments, a contact angle of about 20° or less (e.g., about 15° or less, about 10° or less, or about 5° or less) indicates a ceramic coating having good wettability. In some embodiments, the ceramic coating has cracks that provide access to the liquid electrolyte. In some embodiments, the cracks can have a width of about 1 μm or more (e.g., about 3 μm or more, about 5 μm or more, about 7 μm or more, or about 9 μm or more) and/or about 10 μm or less (e.g., about 9 μm or less, about 7 μm or less, about 5 μm or less, or about 3 μm or less). The ceramic coating can include pores having a dimension of about 1 μm or more (e.g., about 3 μm or more, about 5 μm or more, about 7 μm or more, or about 9 μm or more) and/or about 10 μm or less (e.g., about 9 μm or less, about 7 μm or less, about 5 μm or less, or about 3 μm or less). The ceramic coating can be directly coated onto the polymeric membrane. The ceramic coating can have a thickness on the polymeric membrane. For example, the thickness of the ceramic coating can vary by less than 10% (e.g., less than 7%, less than 5%, less than 3%, or less than 1%); or from 1% to less than 10% (e.g., from 1% to less than 7%, from 1% to less than 3%, or about 1%) on a surface of the polymeric membrane. The polymeric membrane can include a polymer such as polyethylene, polypropylene, and/or copolymers thereof.

The separator of the present disclosure can be made, for example, by providing a slurry comprising a ceramic powder (e.g., a LATP powder and/or a doped LATP powder), a polymeric binder, and a solvent; coating the slurry on the polymeric membrane to provide a coated polymeric membrane; and drying the coated polymeric membrane to provide the separator.

In some embodiments, the slurry coating can be applied to the polymeric membrane with a doctor blade. The slurry can include, for example, 95 wt % Li-ion conductor powder and 5 wt % binder (PVDF and/or PEO), in a solvent such as N-methyl pyrrolidone or N,N′-dimethylformamide. In some embodiments, the slurry can be cast, sputtered, and/or spin coated on the polymeric membrane. In certain embodiments, the slurry is applied at a thickness of about 15 μm or less. Once the slurry has been applied onto the polymeric membrane, the slurry can be dried in vacuum at a temperature that maintains the integrity of the polymeric membrane.

### Lithium-Containing Battery

The separator described above can be incorporated into a lithium-containing battery. Thus, the lithium-containing battery can include an anode, a cathode, and a separator of the present disclosure between the anode and the cathode.

In some embodiments, during operation of the battery, the lithium-containing battery including a ceramic-coated separator of the present disclosure does not have lithium dendrites that penetrate through the separator to provide electrical contact between the cathode and the anode over at least 100 charge-discharge cycles (e.g., at least 200 cycles, at least 300 cycles); or over 100 or more (e.g., 200 or more, 300 or more, or 400 or more) and/or 500 or less (e.g., 400 or less, 300 or less, or 200 or less) charge-discharge cycles.

In some embodiments, during operation of the battery, the lithium-containing battery including a separator that is coated on one surface with a ceramic coating of the present disclosure does not contain lithium dendrites having a length of greater than about 30 μm (e.g., greater than about 25 μm, greater than about 20 μm, greater than about 15 μm, greater than about 10 μm, greater than about 5 μm, or greater than about 1 μm) over at least 100 charge-discharge cycles (e.g., at least 200 cycles, at least 300 cycles). In some embodiments, the lithium-containing battery including a separator that is coated on one surface with a ceramic coating of the present disclosure does not contain lithium dendrites having a length of greater than about 30 μm (e.g., greater than about 25 μm, greater than about 20 μm, greater than about 15 μm, greater than about 10 μm, greater than about 5 μm, or greater than about 1 μm), over 100 or more (e.g., 200 or more, 300 or more, or 400 or more) and/or 500 or less (e.g., 400 or less, 300 or less, or 200 or less) charge-discharge cycles. The lithium dendrites can take the form of needles, which can each independently have a diameter of about 1 μm or less (e.g., 800 nm or less, 600 nm or less, 400 nm or less, or 200 nm or less).

In some embodiments, during operation of the battery, the lithium-containing battery including a separator that is coated on both opposite surfaces, each surface with a ceramic coating of the present disclosure, does not contain lithium dendrites having a length of greater than bout 30 μm (e.g., greater than about 30 μm, greater than about 25 μm, greater than about 20 μm, greater than about 15 μm, greater than about 10 μm, greater than about 5 μm, or greater than about 1 μm) over at least 100 charge-discharge cycles (e.g., at least 200 cycles, at least 300 cycles). In some embodiments, the lithium-containing battery including a separator that is coated on both opposite surfaces, each surface with a ceramic coating of the present disclosure, does not contain lithium dendrites having a length of greater than 35 μm (e.g., greater than about 30 μm, greater than about 25 μm, greater than about 20 μm, greater than about 15 μm, greater than about 10 μm, greater than about 5 μm, or greater than about 1 μm), over 100 or more (e.g., 200 or more, 300 or more, or 400 or more) and/or 500 or less (e.g., 400 or less, 300 or less, or 200 or less) charge-discharge cycles. The lithium dendrites can take the form of needles, which can each independently have a diameter of about 1 μm or less (e.g., 800 nm or less, 600 nm or less, 400 nm or less, or 200 nm or less).

In certain embodiments, during operation of the battery, the lithium-containing battery including the separator of the present disclosure does not contain lithium dendrites having a length of greater than about 1 μm, over at least 100 charge-discharge cycles (e.g., at least 200 cycles, at least 300 cycles). In some embodiments, the lithium-containing battery including the separator of the present disclosure does not contain lithium dendrites having a length of greater than about 1 μm, over 100 or more (e.g., 200 or more, 300 or more, or 400 or more) and/or 500 or less (e.g., 400 or less, 300 or less, or 200 or less) charge-discharge cycles. The lithium dendrites can take the form of needles, which can each independently have a diameter of about 1 μm or less (e.g., 800 nm or less, 600 nm or less, 400 nm or less, or 200 nm or less).

In some embodiments, the lithium-containing battery is a lithium-ion battery. For example, the anode can include graphite or graphene; the cathode can include a lithium-containing layered oxide, a lithium-containing polyanion, or a lithium-containing spinel.

In some embodiments, the lithium-containing battery is a lithium battery (e.g., a lithium metal battery). For example, the anode can include metallic lithium; the cathode can include a metal oxide (e.g., manganese oxide).

In some embodiments, the lithium-containing battery includes a Li/Li symmetric cell with a separator including a LATP coating; a Li/Cu cell with a separator including a LATP coating; and/or a Li/NMC cell with a separator including LATP coating with an active lithium loading of 4 mAh cm⁻².

The lithium-containing battery can be rechargeable.

During operation, the lithium-containing battery can a thermal stability shown by a thermal shrinkage of about 10% or less (e.g., about 7% or less, about 5% or less, or about 3% or less) at 120° C. over a period of about 30 minutes. In some embodiments, the lithium-containing battery has a thermal shrinkage of about 10% or less (e.g., about 7% or less, about 5% or less, or about 3% or less) and/or about 1% or more (e.g., about 3% or more, about 5% or more, or about 7% or more) at 120° C. over a period of about 30 minutes. Thermal stability, crucial for battery safety under high temperatures or thermal runaway, is noticeably improved by the ceramic-coated separator of the present disclosure.

In some embodiments, the lithium-containing battery is capable of being charged at a rate of up to or equal to 5 C (e.g., up to or equal to 4 C). For example, the charging rate of the lithium-containing battery can be 2 C or more (e.g., 3 C or more, or 4 C or more) and/or 5 C or less (e.g., 4 C or less, or 3 C or less). As used herein, C refers to the charging and discharging rate, where, for example, 1C refers to charge/discharge in 1 hour, 2C refers to charge/discharge in ½ hour, 3C refers to charge/discharge in ⅓ hours, and C/2 refers to charge/discharge in 2 hours, etc. The lithium-containing battery can have a cyclability of about 300 cycles or more (e.g., or about 400 cycles or more) and/or about 500 cycles or less (e.g., or about 400 cycles or less) with a capacity loss of about 20% or less. In some embodiments, the lithium-containing battery has a can be cycled about 300 times with a capacity loss of about 20% or less.

The lithium-containing battery can be assembled using conventional techniques, using a separator of the present disclosure, as known to a person of ordinary skill in the art.

Methods of testing the lithium containing battery and characterizing the ceramic-coated separator are known to a person of ordinary skill in the art. Embodiments of testing methods are also described in the Example below.

As will be shown by the Example below, Li/Li symmetric cells including LATP-coated separators, using carbonate electrolyte (1 M LiPF₆ in mixed EC/EMC (3:7 by weight) solvent with 2% vinyl-carbonate (VC) additive); when compared to the analogous cell with pristine separator that shows a rapidly increased polarization after only 50-hour cycling at a current density of 1.0 mA cm⁻², the cell with LATP-coated separator has a much improved cycling stability (stable cycle for more than 150 h at 1.0 mA cm⁻²). Analyses of the cells show that the Li metal anodes in cells including LATP-coated separators can be well protected due to the formation of a stable SEI layer on the surface of the separator.

Li/Cu cells with LATP-coated separators, forms in situ a strong SEI on the Li metal surface, which separates Li from the electrolyte, uptakes electrolyte, and improves the coulombic efficiency of Li metal anode compared with cells including pristine separators.

Li/NMC cells with active material loading of 4 mAh cm⁻² have improved rate capabilities compared to cells including pristine separators, which can be attributed to improved electrolyte wettability. LATP-coated separator improves the cycling stability of Li/NMC cell, even when discharging at a high current density of ˜1.4 mA cm⁻². The cell with LATP-coated separator can retain ˜85% initial capacity after 250 cycles, outperforming the cell with pristine separator.

### EXAMPLE

### Example 1. Ceramic-Coated Separators and Batteries Including the Ceramic-Coated Separators

The low specific capacity of graphite anode in commercial Li-ion batteries largely limits their energy density to below 300 Wh kg⁻¹. Further improvement of the energy density of LIB is possible by replacing the graphite anode with other high energy anodes, such as Li metal. Challenges to implementation of Li metal anodes include, but are not necessarily limited to: the dendritic Li growth due to the intrinsically inhomogeneous current density distribution during Li stripping/plating, low Coulombic efficiency, and thus short cycle life, attributable to the strong reactivity of Li metal with the carbonate electrolyte and infinite volume change during cycling, prohibiting forming stable SEIs. In this Example, Li-ion conductors are coated on the separator inside Li metal batteries. The effects of the coating layer include i) physically separating liquid electrolytes and the Li metal, ii) minimizing and blocking Li dendrite growth, and iii) uptaking electrolyte. These three attributes of the Li-ion conductor coating, if realized, could greatly improve the Coulombic efficiency of Li metal by mitigating the Li/electrolyte contact and reactions, inhibiting Li dendrite formation and penetration, and thus improve cycling stability and safety, while retaining the cell kinetics intact owing to the high ionic conductivity of the Li-ion conductors.

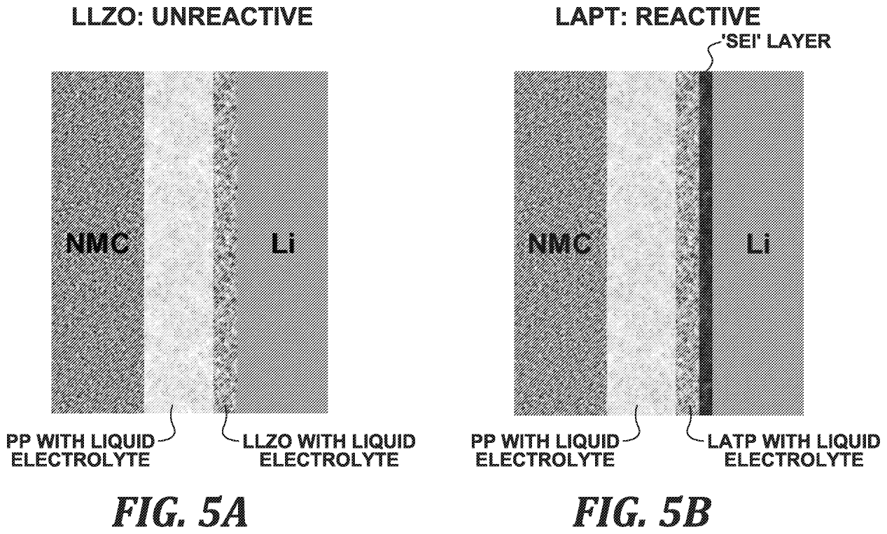

Two kinds of Li-ion conductors were considered, and their interactions with Li metal and effects on cycling behaviors of Li metal were presented and compared in, as shown in FIGS. 5A and 5B. FIG. 5A illustrates the case of garnet-type LLZO which was stable against Li metal, and the LLZO coating was designed as an artificial SEI layer to physically block Li dendrite penetration and separate Li metal from the electrolyte. FIG. 5B illustrates the second case of NASICON-type LATP, which was highly reactive with Li metal. LATP-coating was designed to block the Li dendrites by chemical reactions and to in situ formation of an ‘SEI’ layer in between Li and the coating layer. This artificial SEI layer was strong, and could more effectively separate Li from the liquid electrolyte.

Li-ion conductors, i.e., LLZO and LATP, were provided. Both materials were synthesized by a high temperature solid-state reaction method and then subjected to a ball milling process to control the particle size. For LLZO, stoichiometric amounts of LiOH, ZrO₂, La₂O₃, Ga₂O₃ powders were thoroughly mixed by high-energy ball milling for 0.5-2 hours, and then cold-pressed into pellets, which were then sintered at 800-1000° C. in air for 6-10 hours. The sintered pellets were crushed and ball milled for 4-10 hours to obtain nanopowders having a particle size of about 10 nm to about 500 nm. Similarly, LATP was prepared by using Li₃PO₄, Al₂O₃, and TiO₂ as precursors. The conductivity of the two materials were calculated from the electrochemical impedance spectroscopy (EIS) data measured in pellets densified by a spark plasma sintering (SPS) technique at 900-1100° C. for 5 min. The relative density of the pellets is above 98%. Prior to the EIS measurements, Ag or Au was sprayed or sputtered on both surfaces and acted as the current collectors.

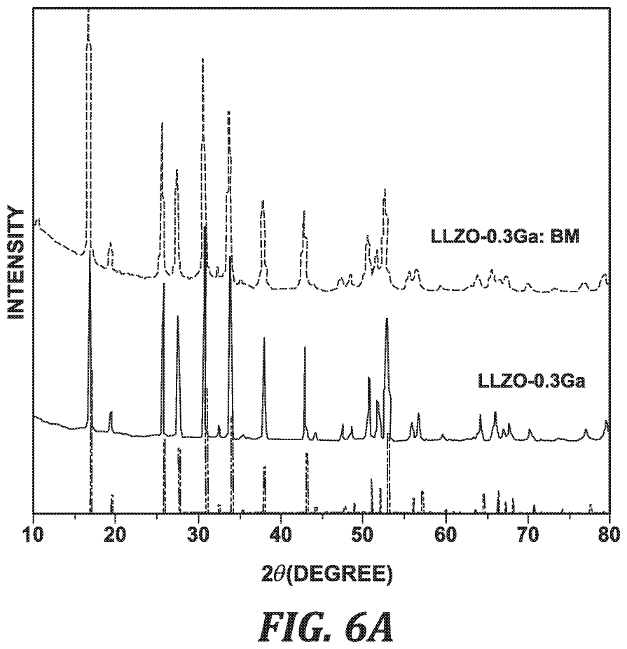

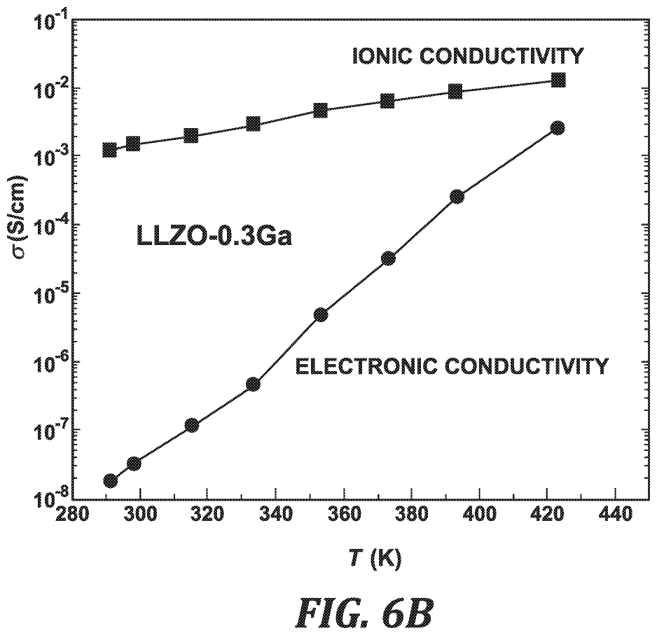

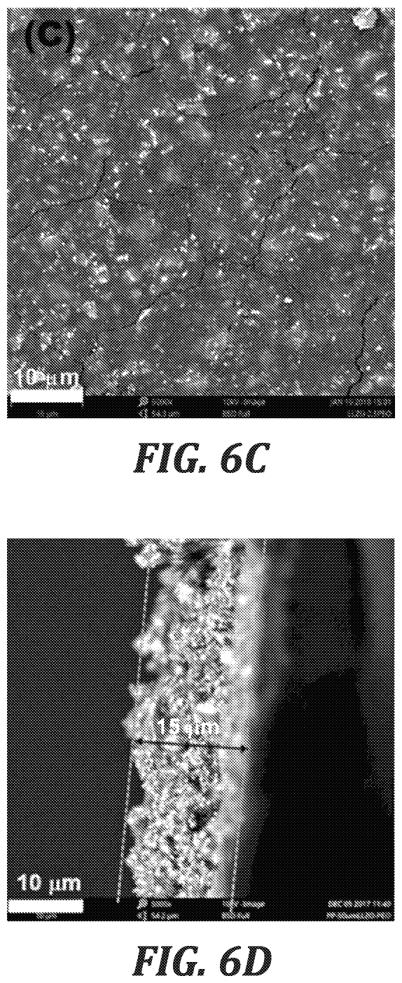

FIG. 6B illustrates the ionic and electronic conductivities of LLZO. At 300 K the ionic conductivity of LLZO was ˜1.5×10⁻³ S cm⁻¹ and the electronic conductivity was ˜5×10⁻⁸ S cm⁻¹, indicating LLZO was a pure ionic conductor with negligible electronic conduction. The ionic conductivity shown in this Example was one of the highest values reported for LLZO. The activation energy calculated from the temperature dependent ionic conductivity was ˜0.27 eV. The slurry coating of LLZO/5 wt. % PEO (PEO: Poly(ethylene-oxide), Mₙ ˜100000-600000) was carried out using a doctor blade and the thickness was controlled by adjusting the blade gap. PEO was the binder and its amount could be adjusted to control the coating thickness, morphology, etc. Subsequently, the separator with coating was dried in vacuum at 30-60° C. for 10-24 h to remove the solvent (DMF). FIGS. 6C and 6D illustrate the morphology and cross section of the coating. The coating was uniform and there were cracks to allow for electrolyte penetration. The particle size of LLZO particles was several hundreds of nanometers. The thickness of coating was ˜15 μm and could be controlled to 1 μm by slurry coating or to hundreds of nanometers by other techniques, such as spin coating.

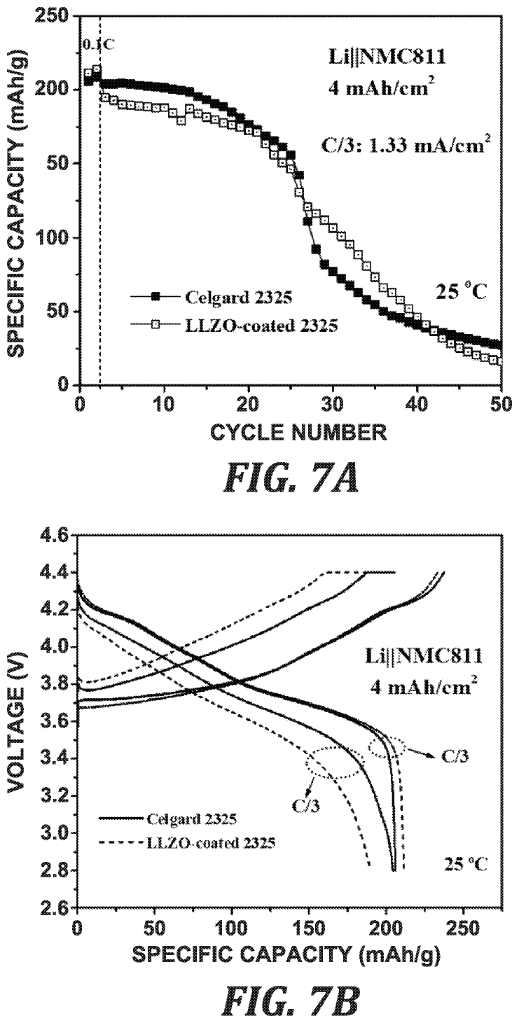

FIG. 7A illustrates the cycling stability of Li/NMC811 cells (4 mAh cm⁻²) with pristine and LLZO-coated separators, at a current density of C/3 (C=200 mA/g) and 25° C. NMC811 (LiNi_{0.8}Mn_{0.1}Co_{0.1}O₂) cathode was prepared by thoroughly mixing 96 wt. % the active material, 2 wt. % carbon black, and 2 wt. % polyvinylidene fluoride (PVDF) in N-methyl-2-pyrrolidone (NMP) in a planetary centrifugal mixer (30 min), casting the slurry on Al foils (20 μm) using an automatic film coater with a doctor blade, and subsequently drying in vacuum at 120° C. for 12 h to remove the NMP solvent. The cathodes were assembled in 2032-type coin cells with 250 μm thick Li foils as the anodes, 25 μm polypropylene separators (Celgard 2325), and a solution of 1.0 mol L⁻¹ LiPF₆ in ethylene carbonate and ethyl-methyl carbonate (3:7 wt/wt) with 2 wt. % vinyl carbonate (VC) as the electrolytes. The high loading Li/NMC cells with pristine and LLZO-coated separators both delivered an initial specific capacity of ˜210 mAh g⁻¹ at C/10, but experienced a rapid capacity fading after 10 C/3 (1.33 mA cm⁻¹) cycles, primarily due to rapid decay of Li metal anode and dry-up of the electrolytes. Nonreactive LLZO-coating did not improve the cycling stability, which indicated the coating layer did not effectively separate Li from the electrolytes. Without wishing to be bound by theory, it is believed that because there was no stable SEI forming on Li surface or LLZO, the electrolytes could still penetrate the coating layer and react with Li. FIG. 7B illustrates the voltage profiles of the cells with pristine and LLZO-coated separators cycled at C/10 (1^{st} cycle) and C/3 (5^{th} cycle). At C/10, the two cells showed similar voltage profiles, while the cell with LLZO-coated separator showed a large voltage polarization at C/3, indicating a larger impedance for the coated cell. Thus, the coating adversely influenced the ion kinetics by reducing the permeability of the separator. Therefore, it is believed that unreactive LLZO-coating on a separator could effectively separate the Li metal from liquid electrolytes, and thus the continuous Li/electrolyte reactions provided a thick SEI, dead Li, as well as electrolyte dry-up, leading to rapid termination of the cell.

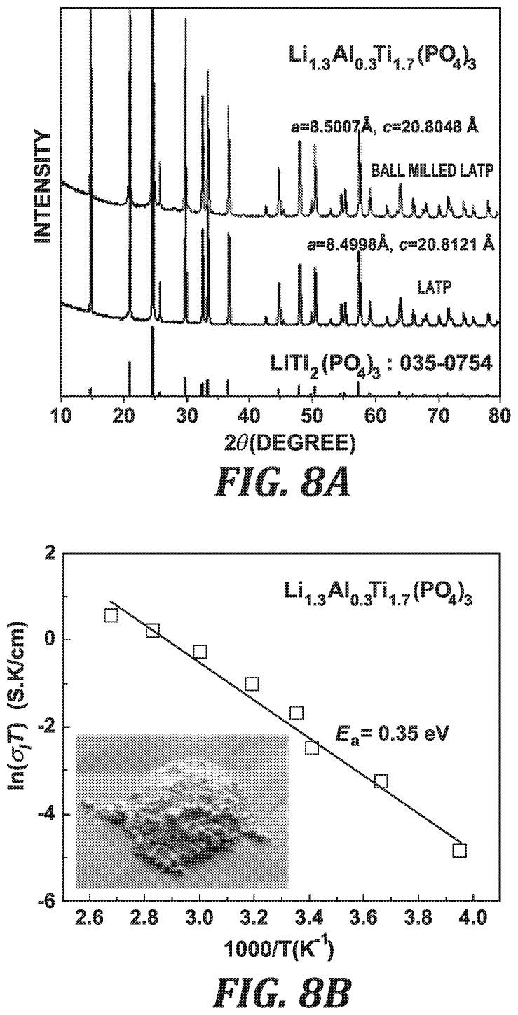

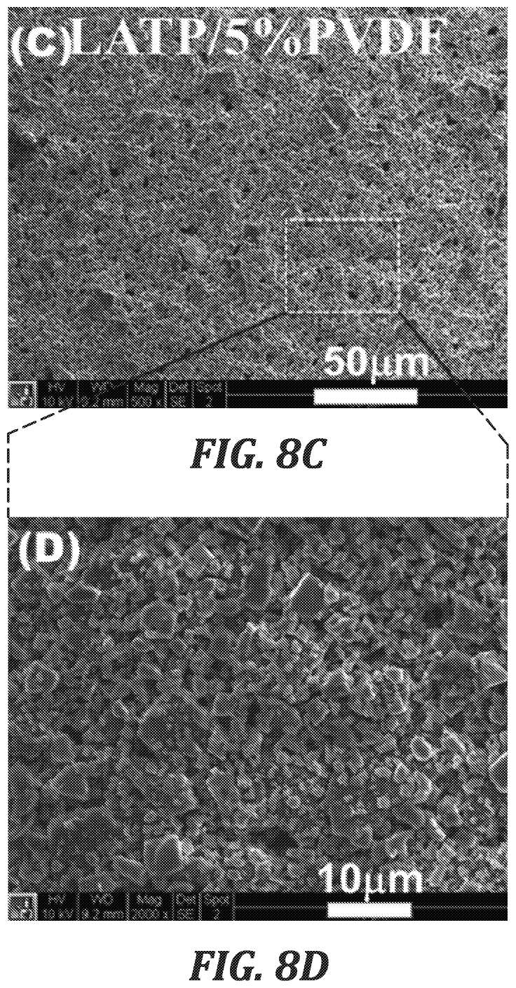

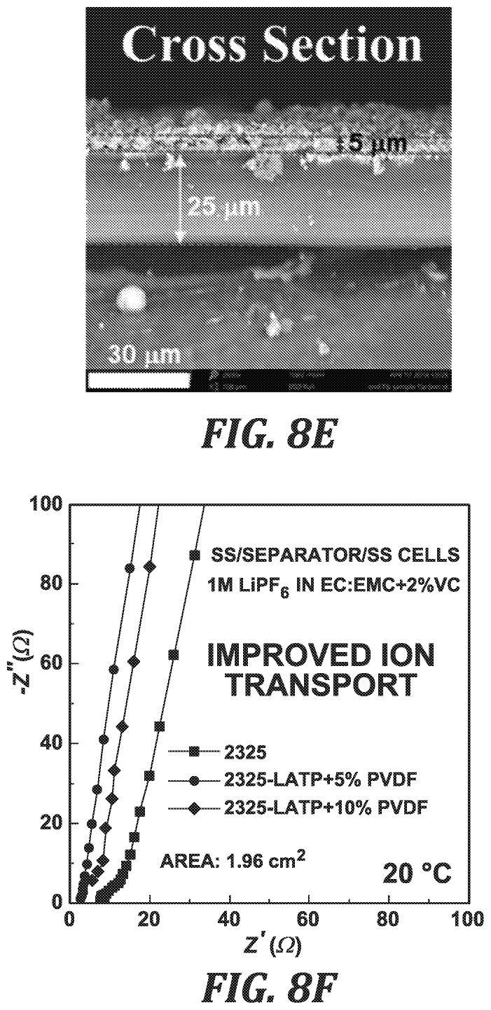

In contrast, the reactive LATP played a distinct role in Li metal protection, as shown in the following implementation. FIG. 8A illustrates the X-ray diffraction (XRD) patterns of as-synthesized and ball-milled LATP. Both powders crystallized into NASICON-type structure (space group 167, R3c) without any detectable impurity phase. FIG. 8B illustrates the temperature dependence of ionic conductivity of a LATP pellet densified by SPS. The ionic conductivity at 300 K was ˜6×10⁻⁴ S cm⁻¹ and the activation energy for Li-ion hopping was ˜0.35 eV. FIGS. 8C and 8D illustrate the surface morphology of the LATP/5 wt % PVDF coating. The coating was uniform, and no PVDF could be detected from the images. The particle size of LATP showed a large variation from 100 nm to several micrometers. FIG. 8E illustrates the cross section of coating, and in this implementation the coating thickness was controlled to be 5 μm. FIG. 8F illustrates the electrochemical impedance results of pristine and LATP-coated Celgard 2325 assembled in stainless steel (SS) symmetric cells. The separators were sandwiched in between two SS spacers (15.6 mm in diameter and 0.5 mm thick) and wetted by the 75 μL carbonate electrolyte. The cells with LATP-coated separators showed small impedances (roughly read as the intercepts with the real axis), as compared to the cell with pristine separator, mainly due to the improved electrolyte wettability of the coating which promotes the ion transport. Therefore, the LATP-coated separators functioned properly and the coating did not impede the ion transport.

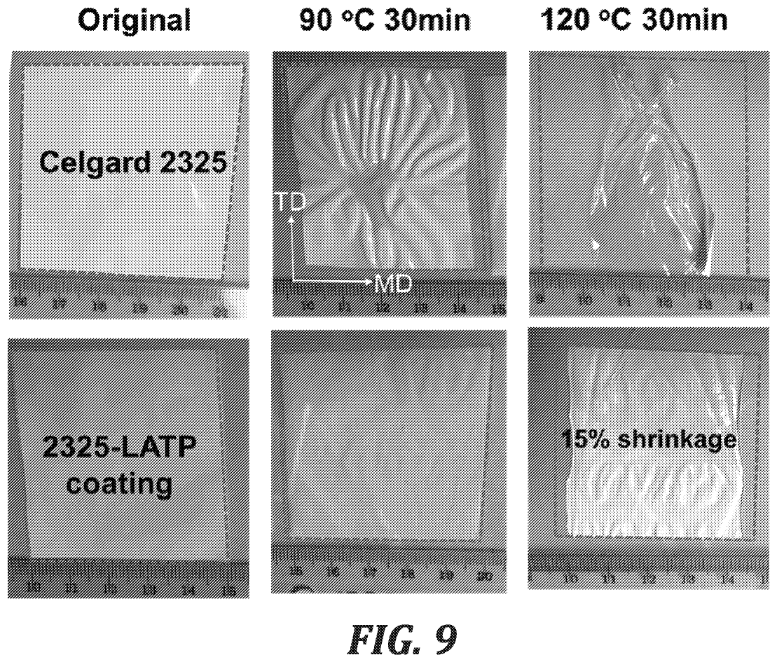

The thermal stability of the separator is very important for the safety of batteries, especially for suppressing or preventing the thermal runaway. The thermal shrinkages of the pristine and LATP-coated separators were tested at 90° C. and 120° C. for 30 min. FIG. 9 shows photographs of the pristine and LATP-coated separators after heat treatment. Upon heating at 90° C. for 30 min, the pristine separator showed shrinkage and partially turned transparent, indicating partial melting of the separator, while the LATP-coated separator was intact. In addition, after 30 min 120° C. heating, the pristine separator completely shrank and became transparent, implying poor thermal stability of the pristine separator. In contrast, the coated separator only shrank by ˜15%, and no melting occurred for the coated separator. All these indicate greatly improved thermal stability when a LATP coating was used.

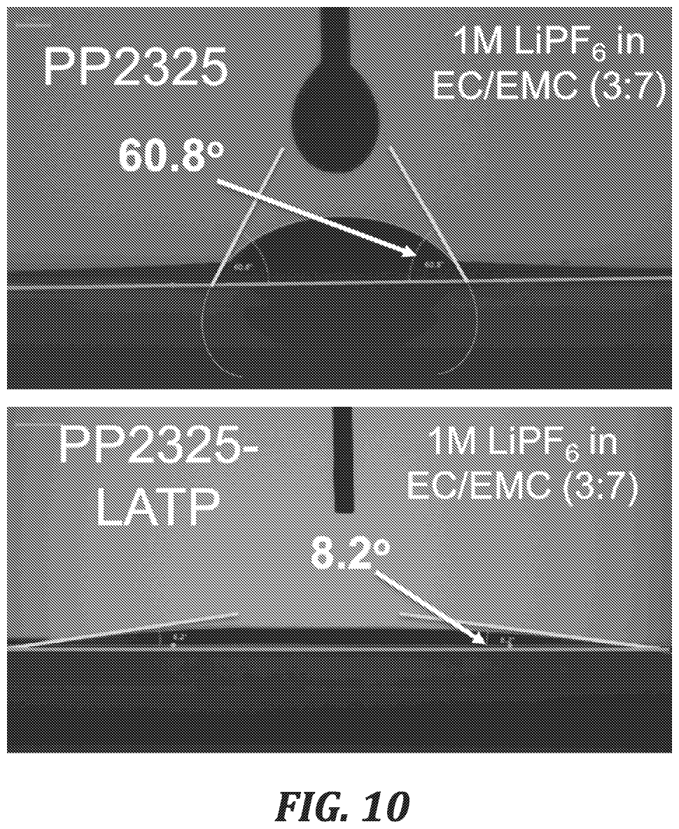

The wettability of the two separators with carbonate electrolyte was provided. The complete wetting of the hydrophobic PP or PE separator with polar carbonate electrolyte was critical for battery kinetics and rate performance. FIG. 10 illustrates the electrolyte wettability tests of pristine and LATP-coated separators. The pristine Celgard 2325 separator showed a contact angle of ˜61°, indicating a poor wetting. The contact angle of the coated separator with carbonate electrolyte was significantly reduced to 18 8.2°, indicating a much improved wettability by the LATP-PVDF coating. The PP or PE separator was naturally hydrophobic and thus showed a large contract angle with the polar carbonate electrolyte. The coating layer, mainly LATP, was hydrophilic and thus displayed a strong affinity with the carbonate electrolytes. In addition, the hydrophilicity of the coating aided the electrolyte uptake and facilitated ion transport, contributing to the decreased impedance demonstrated in FIG. 8F.

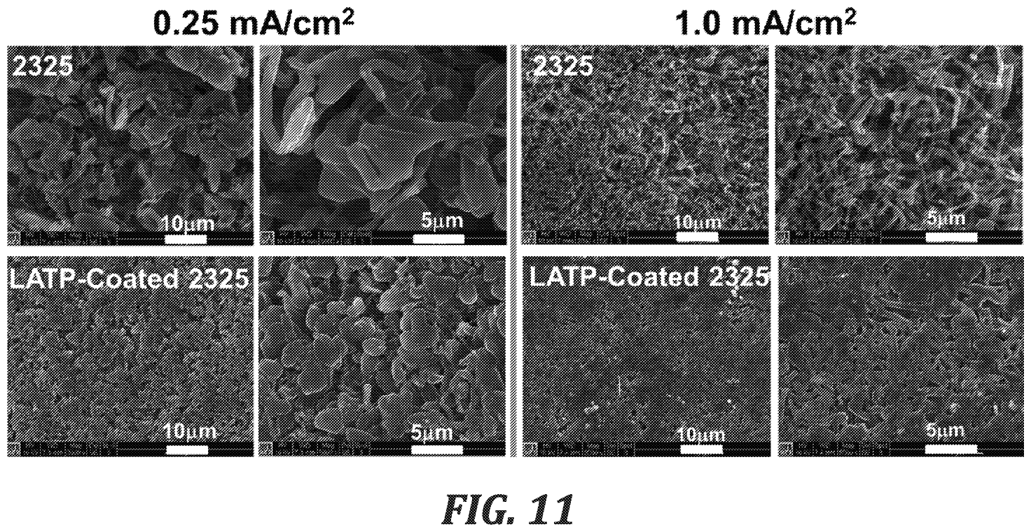

The Li Coulombic efficiency was also investigated. The Li deposition process was important for the Coulombic efficiency and cycle life of Li metal anode. In general, uniform Li deposition provided large and flat deposits, which was beneficial for forming stable SEI and alleviating Li/electrolyte reactions. FIG. 11 illustrates the morphology of Li deposits on Cu cathode at two different current densities (0.25 and 1.0 mA cm⁻²) with a deposition energy density of 1.0 mAh cm⁻². At a small current density of 0.25 mA cm⁻², Li deposited in the cell with pristine separator were mainly nodule-like and showed a large size of ˜5-10 μm; with LATP coating, the Li deposits were almost spherical with a size of ˜5 μm and were much more uniform than those of pristine separator. At a high current density of 1.0 mA cm⁻², the deposits for the pristine separator were mainly Li wires or dendrites with a diameter of hundreds of nanometers and a length of several micrometers. On the contrary, the deposits in the cell with LATP-coated separator were uniform and large (with a size of 5-10 μm), and most importantly, no Li wire and dendrite were found. The above results indicate the LATP-coating could considerably homogenize the current density, impede formation of Li dendrites, and mitigate the Li/electrolyte reactions by forming a stable SEI.

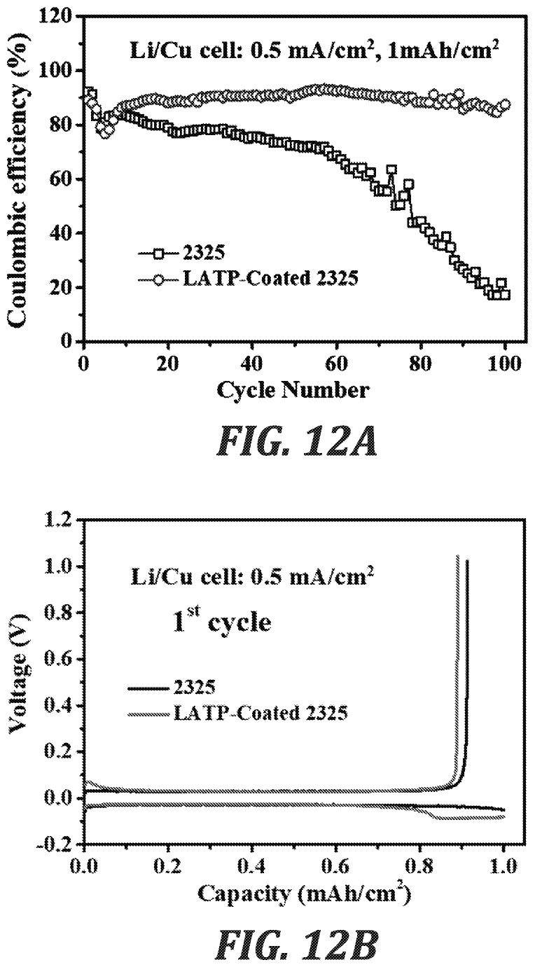

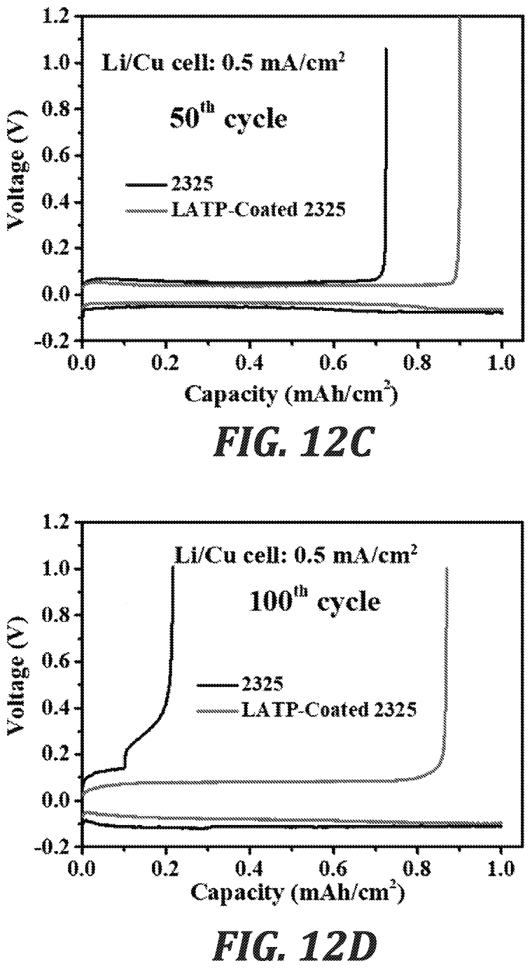

FIGS. 12A-12D illustrate the Coulombic efficiency (η) and voltage profiles of the Li/Cu cells with pristine and LATP-coated separators. The cycling was carried out at a current density of 0.5 mA cm⁻² in this implementation. The Li deposition amount on Cu cathode was 1.0 mAh cm⁻² for every cycle and the stripping cut-off voltage is 1.0 V. Li metal showed intrinsically low Coulombic efficiency in carbonate electrolyte due to their high reactivity and unstable SEI. The cell with pristine separator showed an initial η value of ˜90% and decreased gradually with cycling. After 100 cycles the η value was reduced to less than 20%. The largely decreased efficiency of Li metal anode was attributed to the rapid build-up of voltage polarization, tracing back to the thickened SEI (dead Li) and largely increased impedance. This was evidenced by the voltage profile in FIG. 12D. The cell with LATP-coating showed similar η values as the pristine cell in the initial 10 cycles, however, it retained η values of 85% in the following cycles, giving rise to an average η value of 89.3%, in sharp contrast to ˜63.5% for the pristine cell.

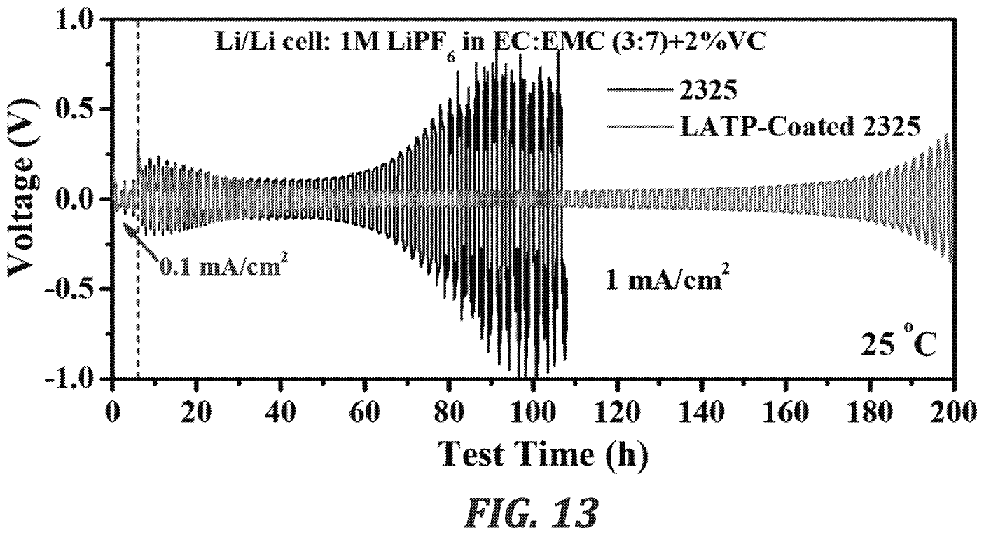

The effects of the LATP-coating were further verified in Li/Li symmetric cells with carbonate electrolyte. FIG. 13 compares the cycling stability of the symmetric cells with pristine and coated separators, cycled at current density of 1.0 mA cm⁻². The cell with pristine separator started to degrade after only 50 hours cycling, evidenced by the largely increased voltage polarization and significant voltage fluctuations. The large voltage fluctuation indicated the occurrence of electrolyte dry-up and/or internal micro-short by the Li dendrites. On the contrary, the cell with LATP-coated separator was stably cycled up to 150 hours, and then the polarization began to increase slowly. The subsequent increase in voltage polarization was mainly due to the increased thickness of SEI layer, however, the cycle life of Li metal anode was tripled. The improvement in cycling stability was mainly due to the homogenized current density and physical separation of Li/electrolyte by coating and in situ-formed SEIs. More importantly, Li dendrites formation was completely inhibited.

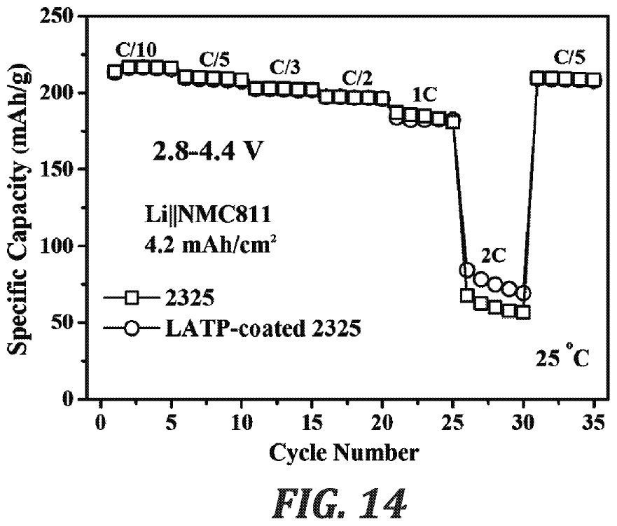

Li/NMC811 high loading cells (4 mAh cm⁻²) were provided to further verify the applicability of the coated separators in Li-metal cells. FIG. 14 compares the rate capability of the two cells with pristine and LATP-coated separators. The two cells showed a comparable rate capability, indicating the coated separator functioned well and the coating did not impede the ion transport. This was attributed to the improved wettability and high ionic conductivity of the coating material, which compensated for the adverse influence of the increased tortuosity and thus increased transport path for the Li ions.

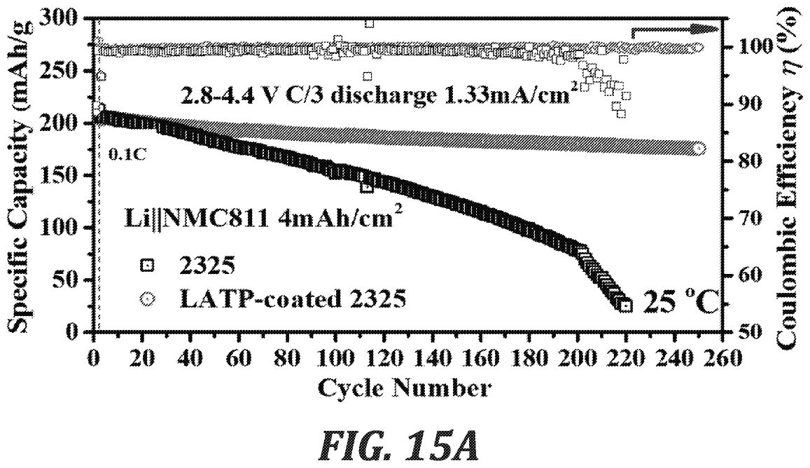

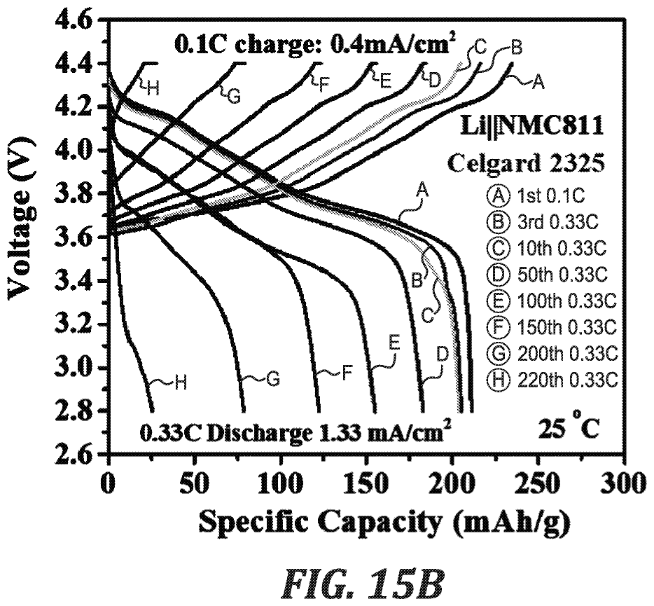

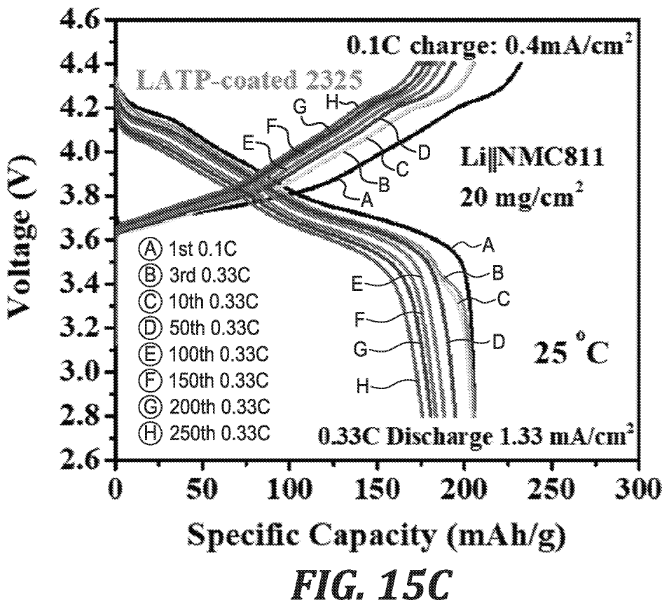

FIG. 15 illustrates the cycling stability of the two cells with pristine and LATP-coated separators. Both cells were charged at 0.1 C (0.4 mA cm⁻²) and discharged at 0.33 C (1.33 mA cm⁻²). The cell with pristine separator showed a rapid capacity decay, losing ˜63% capacity after 200 cycles, and then experienced a sudden drop after 200 cycles. This was accompanied by a large decrease of Coulombic efficiency and significantly increased cell polarization, indicating a substantial build-up of impedance in Li metal owing to the thickened SEI and/or electrolyte dry-up. These were verified by the post-mortem examination of the cycled cell with dark, thick, and porous SEI layer on Li anode and electrolyte dry-up. The cell with LATP-coated separator, however, showed very stable cycling, retaining ˜85% capacity after 250 cycles. The improved cycle stability of the cell with LATP-coated separator was also substantiated by a high average η of ˜99.47%, as compared to ˜98.82% for the pristine cell. These results clearly demonstrated the improved Coulombic efficiency and cycle life of Li anode by the separator coating.

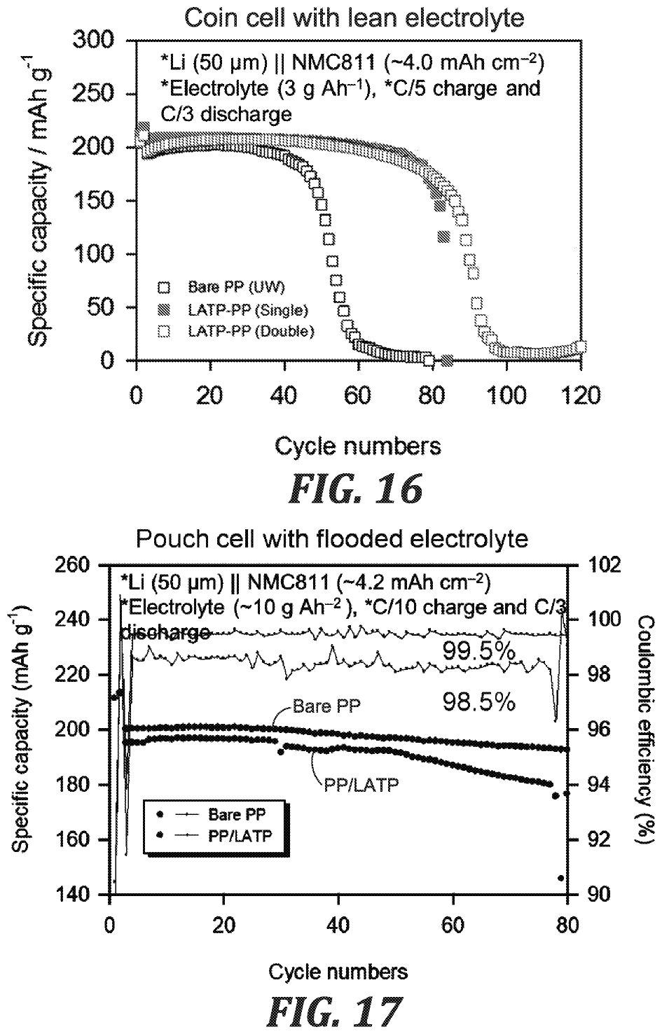

FIG. 16 is a graph of the specific capacity vs. cycle number for a coin cell using LATP-coated PP separator. The coin cell using LATP-coated PP separator shows better cycling performance than that of using bare PP. FIG. 17 is a graph of the specific capacity vs. cycle number for a pouch cell using LATP-coated PP separator. The pouch cell was assembled using known industry standard methods, as described, for example, in energystorage.pnnl.gov/facilities.asp. The pouch cell shows a higher Coulombic efficiency and a higher capacity retention when using LATP-coated PP separator.

While illustrative embodiments have been illustrated and described, it will be appreciated that various changes can be made therein without departing from the spirit and scope of the disclosure.

1. A separator for a lithium-containing battery, comprising:
a polymeric membrane; and
a ceramic coating on at least one surface of the polymeric membrane,
wherein the ceramic coating is chemically reactive with lithium ions to provide an ionically conductive and electrically insulating surface layer; and
wherein the ceramic coating has a thickness of about 1 μm or more and about 10 μm or less.

2. The separator of claim 1, wherein the ceramic coating has an ionic conductivity of about 0.5 mS/cm or more and about 5 mS/cm or less.

3. The separator of claim 1, wherein the ceramic layer has a shear modulus of about 50 GPa or more and about 60 GPa or less.

4. The separator of claim 1, wherein the ionically conductive and electrically insulating surface layer is a passivating layer.

5. The separator of claim 4, wherein the passivating layer comprises Li₃PO₄, AlPO₄, Li₄P₂O₇, TiPO₄, Li_{c}(AlTi)O₂, where c is 0.1 or more and 1 or less.

6. The separator of claim 1, wherein the ceramic coating has a thickness of about 1 μm or more and about 5 μm or less.

7-10. (canceled)

11. The separator of claim 1, wherein the ceramic coating comprises lithium aluminum titanium phosphate (LATP).

12. The separator of claim 11, wherein the LATP has a formula of Li₁₊ₓAlₓTi₂₋ₓ(PO₄)₃, where x is 0.3 or more and 0.4 or less.

13. The separator of claim 11, wherein the LATP has a formula of Li₁₊ₓAl_{x-y}R_{y}Ti₂₋ₓ(PO₄)₃, where R is one or more dopants, x is 0.3 or more and 0.4 or less, and y is less than x.

14. The separator of claim 13, wherein the one or more dopants R is selected from Fe³⁺, Cr³⁺, Ge⁴⁺, Nb⁵⁺, Ga³⁺, Sc³⁺, Y³⁺, and any combination thereof.

15. (canceled)

16. The separator of claim 1, wherein the ceramic coating is permeable to a liquid electrolyte.

17. The separator of claim 1, wherein the ceramic coating comprises pores having a dimension of about 1 μm or more and/or about 10 μm or less.

18. The separator of claim 1, wherein the ceramic coating is directly coated onto the polymeric membrane.

19. The separator of claim 1, wherein the ceramic coating has a uniform thickness on the polymeric membrane.

20. The separator of claim 1, wherein the polymeric membrane comprises a polymer selected from polyethylene, polypropylene, copolymers thereof, and any combination thereof.

21. A lithium-containing battery, comprising:
an anode,
a cathode, and
a separator of claim 1 between the anode and the cathode.

22. The lithium-containing battery of claim 21, wherein the lithium-containing battery does not contain lithium dendrites having a length of greater than about 35 μm over 100 or more charge-discharge cycles.

23-28. (canceled)

29. The lithium-containing battery of claim 1, wherein the cathode comprises a lithium-containing layered oxide, a lithium-containing polyanion, or a lithium-containing spinel.

30-35. (canceled)

36. The lithium-containing battery of claim 21, wherein the lithium-containing battery has a cyclability of about 300 cycles with a capacity loss of about 20% or less.

37. A method of making a separator of claim 1, comprising:
providing a slurry comprising a LATP powder, a polymeric binder, and a solvent;
coating the slurry on the polymeric membrane to provide a coated polymeric membrane; and
drying the coated polymeric membrane to provide the separator.
